(19) United States
(12) Patent Application Publication
(10) Pub. No.: US 2005/0278349 A1
(43) Pub. Date: Dec. 15, 2005

(54) Data model architecture with automated generation of data handling framework from public data structures

(76) Inventors: Raji Chinnappa, Allentown, NJ (US); Prameela R. Gopu, Morganville, NJ (US); Timothy I. Ross, Fair Haven, NJ (US)

Correspondence Address: Ryan, Mason & Lewis, LLP, Suite 205, 1300 Post Road, Fairfield, CT, 06824, US

(21) Appl. No.: 10/856,431

(22) Filed: May 28, 2004

(51) Int. Cl. G06F 7/00

(52) U.S. Cl. 707/100

(57) ABSTRACT

Methods and apparatus are disclosed for automatically generating a data handling framework to manage public data structures. A customizable framework is generated based on one or more parameters of the public data structures to be managed. A data model architecture is disclosed that features a data model for wrapping public data structures, handling the public data structures and various elements of the public data structures, including validation capabilities for the data. The data model architecture includes an automatically generated module, referred to as the data-handling framework. The data-handling framework wraps public data structures and provides, for example, creation, accessor and modification functions. In addition, the data-handling framework provides mechanisms for tracking changes and a skeleton framework for validation routines. In addition, the data model architecture includes a set of custom, rules-based, validation classes (custom or hand written) that overlay on top of the automatically generated data model classes.

### CROSS-REFERENCE TO RELATED APPLICATIONS

The present application is related to United States Patent Application, entitled “Method and Apparatus for Administering Configuration Information in a Private Branch Exchange Switch,” and United States Patent Application, entitled “Method and Apparatus for Validation and Error Resolution of Configuration Data in a Private Branch Exchange Switch,” each filed May 21, 2004 and incorporated by reference herein.

### FIELD OF THE INVENTION

The present invention relates generally to data management tools, and more particularly, to methods and apparatus for automatically generating a data handling framework to manage public data structures.

### BACKGROUND OF THE INVENTION

With the explosive growth of the Internet, there has been a growing trend towards Internet Protocol (IP) telephony. IP telephony allows various devices, often referred to as end-points, such as dedicated IP phones or specially configured personal computers, to initiate and receive telephone calls over the Internet or private data networks. Generally, the voice signal is compressed and translated into IP packets for transmission over the network(s).

IP telephony offers many benefits to both carriers and users that have contributed to its rapid deployment. Eventually, IP telephony technologies may replace traditional circuit switched telephony technologies, such as the Public Switch Telephone Network (PSTN). In the meantime, however, there is a substantial installed base of traditional telephone systems served by the PSTN and IP telephony must co-exist with traditional telephone systems.

A number of products are available that allow enterprises to integrate their traditional telephone systems, such as private branch exchange (PBX) switches with IP telephony features. The IP Office™ product, commercially available from Avaya, Inc., of Basking Ridge, N.J., supports voice and data communications. IP Office™ can be set up as a traditional PBX, an IP telephony server, or a combination of both. Thus, the IP Office™ product allows an enterprise to immediately implement traditional telephony, and evolve to IP over time, or to immediately implement a full IP solution.

While these emerging IP telephony products effectively allow enterprises to transition to IP telephony communications, some of the products have been difficult to administer. A number of early administration tools for such switches required specific user training and provided little, if any, assistance with the entry of configuration information. In addition, once the configuration information was entered, such administration tools allowed the configuration information to be changed without ensuring the accuracy of such changes or without providing a mechanism to resolve any errors created by the changes.

A need therefore exists for an administration tool for an enterprise telephone switch that provides improved installation and administration, with increased efficiency and reliability.

### SUMMARY OF THE INVENTION

Generally, methods and apparatus are disclosed for automatically generating a data handling framework to manage public data structures. A customizable framework is automatically generated to manage public data structures. The customizable framework is based on one or more parameters of the public data structures. A data model architecture is disclosed that features a data model for wrapping public data structures, handling the public data structures and various elements of the public data structures, including validation capabilities for the data. The data model architecture includes an automatically generated module, referred to as the data-handling framework. The data-handling framework wraps public data structures and provides, for example, creation, accessor and modification functions. In addition, the data-handling framework provides mechanisms for tracking changes and a skeleton framework for validation routines. In addition, the data model architecture includes a set of custom, rules-based, validation classes (custom or hand written) that overlay on top of the automatically generated data model classes.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram of an exemplary administration tool incorporating features of the present invention;

FIG. 3 is a schematic block diagram of an architecture incorporating features of the present invention;

FIG. 4A is a flow chart describing an exemplary automatic generation process incorporating features of the present invention;

FIG. 4B is a flow chart describing an exemplary create validating class subroutine implemented by the automatic generation process of FIG. 4A for each raw data class;

FIG. 5 illustrates portions of exemplary configuration and user classes;

FIG. 6 illustrates an exemplary object template for each Validation object;

FIG. 7A is a table containing an exemplary list of source files and indicates their corresponding function;

FIG. 7B is a table containing an exemplary list of main scripts and indicates their corresponding function;

FIG. 7C is a table containing an exemplary list of secondary scripts that are called by the main scripts of FIG. 7B and indicates their corresponding function;

FIG. 7D is a table containing an exemplary directory structure, indicating a directory name and the corresponding contents;

FIG. 8 illustrates the relationship between various data objects, in accordance with exemplary Unified Modeling Language (UML) conventions;

FIG. 9 illustrates the relationship between the various validation result data classes discussed herein; and

FIG. 10 illustrates an exemplary types reference hash table.

### DETAILED DESCRIPTION

The present invention provides methods and apparatus for automatically generating a data handling framework to manage public data structures. In an exemplary embodiment, an administration tool 200 administers a switch 150, such as a Private Branch Exchange (PBX) switch that optionally provides an IP Telephony feature. The administration tool 200 employs a data model architecture that features a data model for wrapping raw data classes, handling the raw data and its various elements in various ways, including validation capabilities for the data. As discussed hereinafter, the data model architecture includes an automatically generated module, referred to as the data-handling framework. The data-handling framework wraps raw data classes and provides creation, accessor and modification functions, ability to track changes and puts in a skeleton framework for validation routines. In addition, the data model architecture includes a set of custom, rules-based, validation classes (custom or hand written) that overlay on top of the automatically generated data model classes.

Generally, the data-handling module is useful in any software architecture where validation is performed alongside maintaining synchronization with changing raw data classes, as would be apparent to a person of ordinary skill in the art. Raw data needs to be encapsulated often with creation accessor, modification, copy, and deep clone methods. Also, the ability to track if any object has changed and percolate that information to its containers is also desired. The ability to put hooks in for validation is necessary in any system where there are syntax and value constraints in a system. To put hooks in for any action to be done after a delete, modification or add is also part of the framework. This is useful to post changes or propagate changes whenever any object is changed and has been referred to from other endpoints in the system. Furthermore, having the data-handling module work off the raw data classes allows the raw data classes to be available and be exported using, for example, XML through various technologies. The custom rules that are hand written fill in the actual validation that needs to be field-specific and object specific. This is done in a non-automated part of the data model architecture that derives all the benefits of the automatically generated data-handling framework due to inheritance. The present invention thus provides a data model architecture where all the non-custom parts of data handling have been automated.

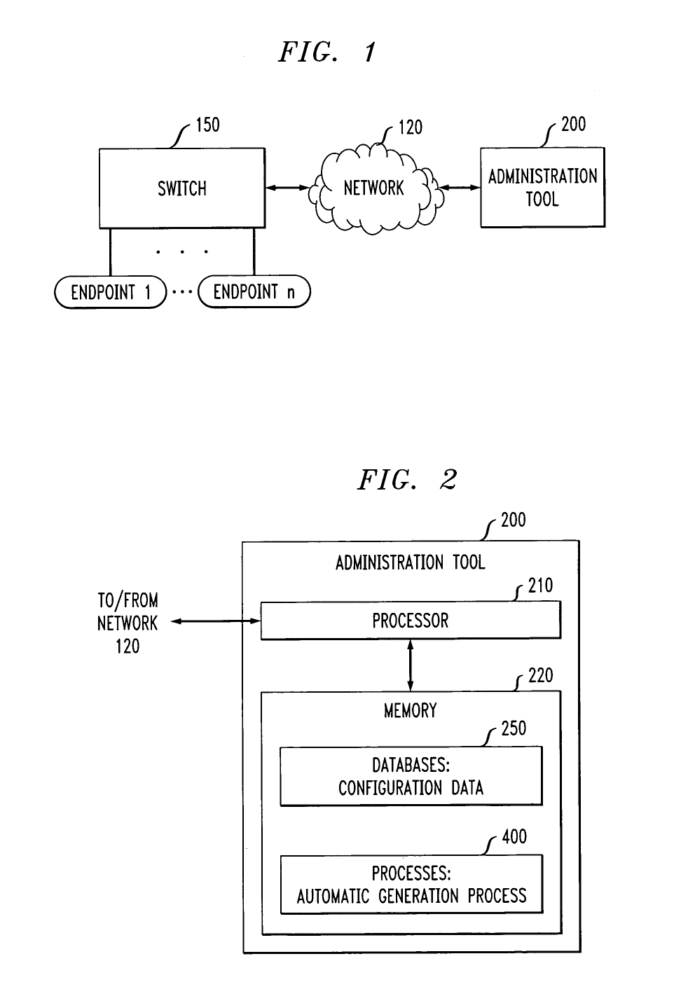

FIG. 1 illustrates an exemplary network environment in which the present invention can operate. As shown in FIG. 1, a user (administrator) employing an administration tool 200, discussed below in conjunction with FIG. 2, configures a switch 150 over a network 120. The network 120 may be embodied as any private or public wired or wireless network, including the Public Switched Telephone Network, a Private Branch Exchange switch, Internet, or cellular network, or some combination of the foregoing. While the present invention is illustrated using a server side implementation, where the features of the present invention are resident on the administration tool 200, the features and functions of the present invention may be deployed on a number of distributed tools 200, as well as on a client associated with the switch 150, or a combination of the foregoing, as would be apparent to a person of ordinary skill in the art.

The switch 150 may be embodied, for example, as the IP Office™ switch. The switch 150 can be set up, for example, as a traditional PBX, an IP telephony server, or a combination of both. The switch 150 connects one or more endpoints 1 through endpoint n. It is noted that the endpoints can be directly connected to the switch 150, as shown in FIG. 1, or can be connected to the switch 150 over the network 120. Similarly, the administration tool 200 can be directly connected to the switch 150, or can be connected to the switch 150 over the network 120 as shown in FIG. 1. As discussed hereinafter, the administration tool 200 can process the configuration data 1600, as discussed further below in conjunction with FIG. 16, for the switch 150 in an online or offline manner. In other words, the administration tool 200 can process the configuration data 1600 whether or not the switch 150 is present.

FIG. 2 is a schematic block diagram of an exemplary administration tool 200 incorporating features of the present invention. The administration tool 200 may be any computing device, such as a personal computer, work station or server. As shown in FIG. 2, the exemplary administration tool 200 includes a processor 210 and a memory 220, in addition to other conventional elements (not shown). The processor 210 operates in conjunction with the memory 220 to execute one or more software programs. Such programs may be stored in memory 220 or another storage device accessible to the administration tool 200 and executed by the processor 210 in a conventional manner.

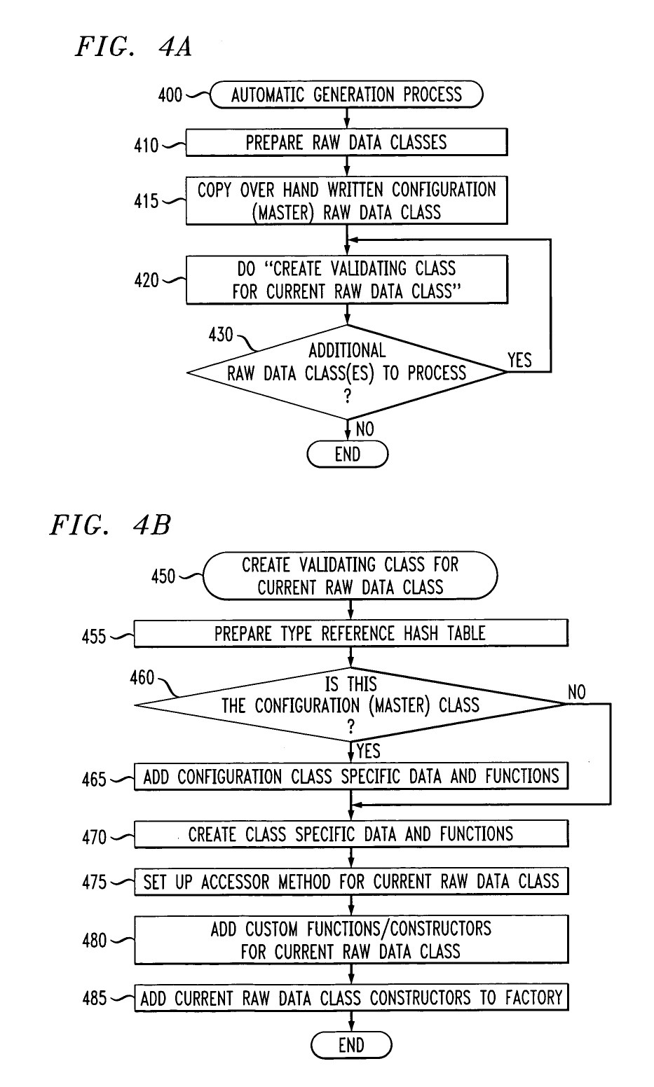

For example, the memory 220 may store configuration data 250. In addition, the memory 220 may store an automatic generation process 400, as discussed further below in conjunction with FIG. 4.

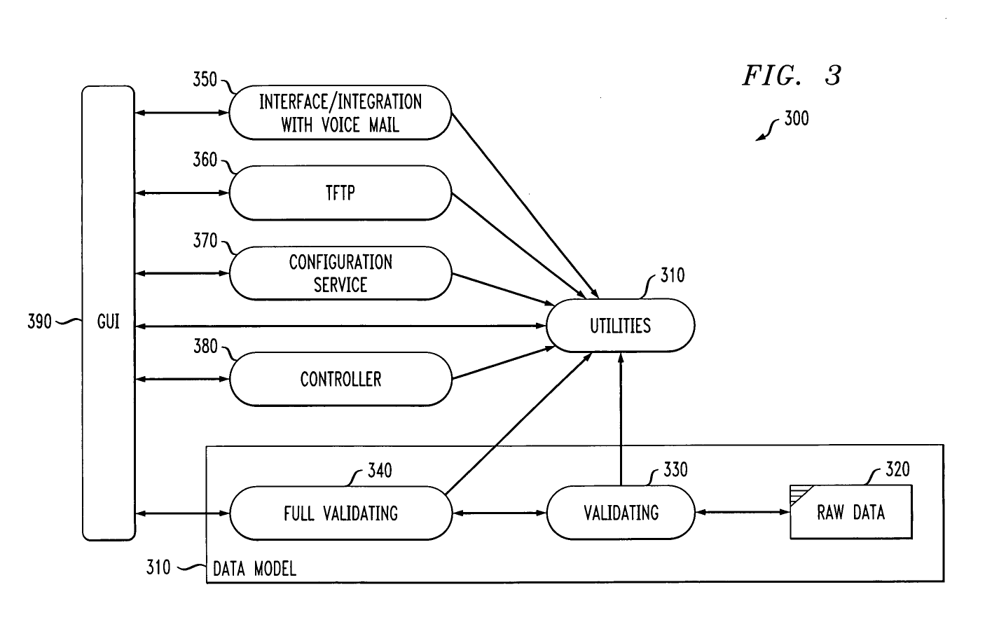

FIG. 3 is a schematic block diagram of an architecture 300 incorporating features of the present invention. As shown in FIG. 3, the architecture 300 includes a data model architecture 310 that comprises a raw data class module 320, an automatically generated data-handling module 330, and a rules-base module 340 that has custom rules for validation. In addition, the architecture 300 includes a utilities module 340 and Graphical User Interface module 390 with auxiliary helper modules 350, 360, 370, 380. The utilities module 340 generates and logs error messages. The voice mail integration module 350 allows the administration tool 200 to be automatically integrated with a voice mail system. The Trivial File Transfer Protocol (TFTP) module 360 used to transfer the data to and from the switch 150_. The configuration service module 370 that reads and writes to the data format required by switch 150, gets a list of switch 150-like systems in the immediate network. The controller module 380 helps the GUI module 390 to manipulate the raw data and also adds on other data structures to provide features like Class Of Service, Reporting capability and error resolution generation.

A number of the architecture features and sub-modules are discussed further below in a section entitled “Data Model Architecture/Sub-Modules.”

FIG. 4A is a flow chart describing an exemplary automatic generation process 400 incorporating features of the present invention. As shown in FIG. 4, the automatic generation process 400 initially prepares the raw data classes during step 410. In an exemplary embodiment, a coreToCSharp script, discussed below in a section entitled “Scripts,” is executed that converts C++ header classes to a raw data class (has only public fields and Arrays) in C#. In step 415, the hand written Configuration (Root) raw data class is copied over. The Root class is defined here as the class whose object will contain all the data of a system. The configuration raw data class has an array of objects, such as user, hunt group and short code objects.

The automatic generation process 400 then invokes a subroutine, Create Validating Class For Current Raw Data Class, discussed further below in conjunction with FIG. 4B, during step 420 to process each raw data class. A test is performed during step 430 to determine if there are additional raw data class(es) to process. If it is determined that there are additional raw data class(es) to process, program control returns to step 420 and continues in the manner described above. If, however, it is determined during step 430 that there are no additional raw data classes to process, then program control terminates.

FIG. 4B is a flow chart describing an exemplary of the create validating class subroutine 450 called by the automatic generation process 400 during step 420. As shown in FIG. 4B, the create validating class subroutine 450 initially prepares a types reference hash table 1000, discussed further below in conjunction with FIG. 10, during step 455. During step 455, the automatic generation process 400 goes through each raw data class and stores all the different elements and their types for future reference in the hash table 1000.

A raw data class is checked during step 460 to see if it is the Configuration (Root) class. During step 465 the following features unique to the Configuration Class are added:
a. a table containing references to all the contained objects (references are unique and are referred to by Oid (Object Identifier), which should be unique in the entire configuration); and
b. an ArrayList, referred to as ModifiedList, that tracks the list of all elements that have been changed from the time this tracking has been triggered (useful, for example, in error tree re-computation).

Steps 470 through 485 are performed for each raw data class. During step 470, a validating class is created for the current raw data class with basic elements. In particular, for each raw data class, its position is fixed in the hierarchy tree for configuration by setting the following parameters:
a. Container—reference to the object that contains it;
b. Container Name—name of object that contains it; and
c. Configuration Reference—reference to the Configuration (Root) object that it belongs to (allowing for multiple configurations to be handled by the data model architecture 310).
   The setting of the Configuration Reference happens when a new object is added to or modified in the configuration. When the reference to the configuration is set, the following are internally triggered:
i. Sets the Configuration reference recursively for all elements that this raw data object might contain;
ii. Registers the object identifier (Oid) with the Oid Hash table of the Configuration; and
iii. Triggers the JoinedConfiguration method to report its new state to UniqueCollections (a repository of unique elements, used for validation).

Steps 475-485 enhance each class with functions appropriate to its contained elements. Many of the functions need to be iterated over the contained elements. This recursive procedure has also been abstracted to be a common procedure that gets called to do any particular function iteratively with the aid of the types reference table 1000 generated during step 455.

The class specific data and functions are created during step 470. In an exemplary implementation, the following class specific data and functions are created:
a. provide a private instance of its raw data object for each class;
b. create default constructors with default values from another input (for example, they ca be collected from C++ classes);
c. copy constructors with another validating class or a raw data class;
d. generate cloning procedures that iterate over any sub elements, i.e., recursively call clone procedure of any contained elements;
e. provide comparison methods to compare any two objects—Deep Equal methods (iterate over any elements that it might contain);
f. create an empty validate function for every element that it contains (iterate over any elements that it might contain); and
g. create an empty validate function for the entire class that in turn calls the validate method or function for each element.

The accessor methods are established for current raw data class during step 475. Depending on type of each element contained in the raw data class (by looking at types reference hash table 1000), the following are created:
a. get function: to return the value;
b. set function that does the following:
   i. puts in code to track changes;
   ii. enforces audit trail mechanism, if turned on at that level;
   iii. validates before setting value and sends back a result;
   iv. sets new values;
   v. provides call backs when element values have changed; and
   vi. sets reference to configuration.

Custom functions and constructors for the current raw data class are added during step 480. For each raw data class, any extensions specified for that class are added to the generated class and if the extension is a constructor, then the constructor is made available to the factory.

During step 485, the current raw data class constructors are added to the factory. As each class needs to be instantiated to create objects, all the different constructors are all automatically compiled and made available through a factory that can be used from anywhere else.

### Data Model Architecture/Sub-Modules

The configuration of the exemplary administration tool 200 is mapped into three C# assemblies under the namespaces Configuration, Configuration.Validating, and Configuration.Validating.Full. Configuration is a C# version of the configuration files suitable to serialize to XML allowing it to be sent over a Web Service interface. The Configuration module contains the raw data classes 320 (FIG. 3). The Configuration namespace is in it's own namespace because it can be thought of as source code for the Scripts generating the ConfigurationValidating namespace. It is possible that the Configuration assembly is created through Web Service discovery.

Configuration.Validating provides the configuration access for the Graphical User Interface. Configuration.Validating also adds the validation structure. Both Configuration and Configuration.Validating are automatically generated from the C++ classes via perl scripts, discussed below. This minimizes the work keeping the application synchronized with the source for the raw data. Configuration.Validating.Full classes inherit from their Configuration.Validating counterparts, filling in the meat of the validation (that is, providing application specific defaults, and all the data manipulation functions) of the raw dataConfiguration Module

The exemplary configuration classes allow the configuration to be easily converted to/from XML using NET's standard System.Xml.Serialization.XmlSerializer. This constraint forces classes to consist of only public data, and not methods. This also forces the configuration to be contained within one object, so instead of having global lists containing users as core_conf.h has, there is one Configuration (Root) object that contains arrays of each object of each configuration type. The XML serializer cannot serialize ArrayLists, so groups of objects are all represented as arrays.

Having the configuration serializable to XML allows the option of sending them over a web service.

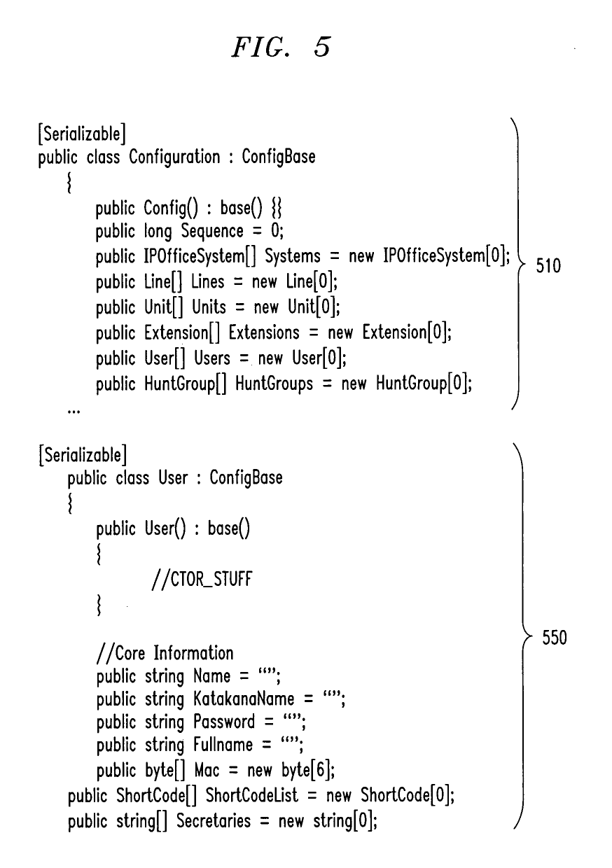

FIG. 5 illustrates portions of exemplary configuration and user classes 510, 550, respectively. Each object has an associated unique object identifier (OID), allowing the object to be uniquely tracked regardless of what data has been changed. The exemplary classes 510, 550 shown in FIG. 5 are automatically generated by the perl script “coreToCsharp” from “core_conf.h,” discussed below. The core_conf.h objects contain a pack and unpackfunction. This was separated out in the translation as XML was being used for the Wizard.

Configuration.Validating Module

As previously indicated, the validating module gets automatically generated using, for example, Perl Scripts, discussed below, and contains classes that are built using the raw data. The Configuration classes are structures. Thus, there is a need for a more abstract interface to the configuration for the rest of the administration tool 200. This interface is provided by the Configuration.Validating classes. Each Configuration class has a corresponding Configuration.Validating class, and it is this Validating class that the administration tool 200 uses to access the configuration.

Distributed software environments and web services typically pass data as simple public structures. This limits the number of function calls across the network. The weakness with this is that the application using the data uses it at its raw level.

In the Configuration.Validating classes, Configuration namespace public attributes become Properties (with set and get functions), Configuration namespace arrays become ArrayLists, and the whole validation structure is added. Each Property has a corresponding validate function, which is called during each Properties set. Each arrayList has a validate function that validates whether adding an element to an ArrayList is valid. Each class also has a Validate( ) function that recursively calls Validate( ) on all of its members. Calling Validate( ) on the configuration object itself will Validate( ) on all the objects of the entire configuration.

Configuration.Validating classes also include a constructor that initialized the data the same way that core_conf.cpp does, and adds a Clone function that implements a Deep Clone.

These classes are automatically generated by the perl script “configToValidating” from their Configuration classes. (The Configuration namespace classes themselves are generated by the perl script “coreToCSharp” from the core switch configuration c++source: “core_conf.h” and “core_conf.cpp,” each discussed below in the Section entitled “Scripts.”

Framework Details

The Scripts, discussed further below, create a framework referred to as a ValidatingConfig, to access the data. The framework adds:
a. a clone function, to create a new object of it's own type (copies data of built in types and strings; each contained object is cloned);
b. conversion of enumerations to strings (rather than C#'s default ToString( ));
c. a default initialization capability;
d. a RawConfiguration function to provide access to raw data;
e. constructors created to create validating objects from Raw configuration and other validating objects
f. a DeepEqual method to determine whether two objects are the same (checks each built in/string data element to determine if it is equal to the other; for each contained object, checks whether it is DeepEqual to the others);
g. mechanism that keeps track of container object of each object (structure);
h. mechanism to keeps track of container of all objects;
i. hooks to validate each element (with defaults returning true);
j. validate function that calls validate of each element;
k. functions to iteratively set Creation/Modification Time (through out whole collection; for example, to track changes);
l. functions to iteratively set Creator/Modifier (through out whole collection; for example, to track changes);
m. generates a unique OID for each object that does not have one set already (verifies that each created OID is unique);
n. function to make all OIDs unique (for an object and recursively for all its contained objects);
o. automatically encrypts/decrypts (for any field with password in it; provides function to EncryptAll recursively for own elements and all contained objects);
p. for each element in raw data that is not an array, creates a get function that returns the element
q. for each element in raw data that is not an array, creates a set function that does the following:
   i. calls validate on data before setting it;
   ii. marks data as changed for itself and each container up the tree;
   iii. calls ReportError hook, if validation fails;
      a. If data is a string, trims the string, and asserts that it is not null; and
      b. If the data is another object, it sets that objects Container as itself, and sets the objects Rootcontainer as it's own.
r. takes raw data arrays, and generates ArrayLists to access them;
s. for these array lists, creates a get function to return the array list.
t. Generates four functions to set the list:
   i. Add—same as set, except first verifies the added object by calling ValidateAddElement hook and if it fails, it does not add, but returns the error result created by the ValidateAddElement hook. Asserts that what is added has a unique Oid. Calls “Added” Hook after “Add” is complete allowing the application to act on the add. If the element added is an object, sets its OurConfiguration (it's Root) to this objects OurConfig, and calls the hook JoinedConfig(newElement).
   ii. Modify—does a Delete, then Add.
   iii. Delete—calls Deleted hook after Deletion is completed so that application can take action.
   iv. DeleteAll—Calls Delete for each element. And calls recursively DeleteAll for each element that is an object
u. a static Factory, so the applications can change the object creations to be descendants of the validating objects. (ValidationConfiguration objects always use this static Factory to create ValidationObjects, so that if the application has it's own inherited version of the ValidationObject, then the application's version will be instantiated).
v. JoinedConfiguration hook—each object has a JoinedConfiguration hook that is called when it is added to/removed from a configuration. This is used by the application to track unique objects.

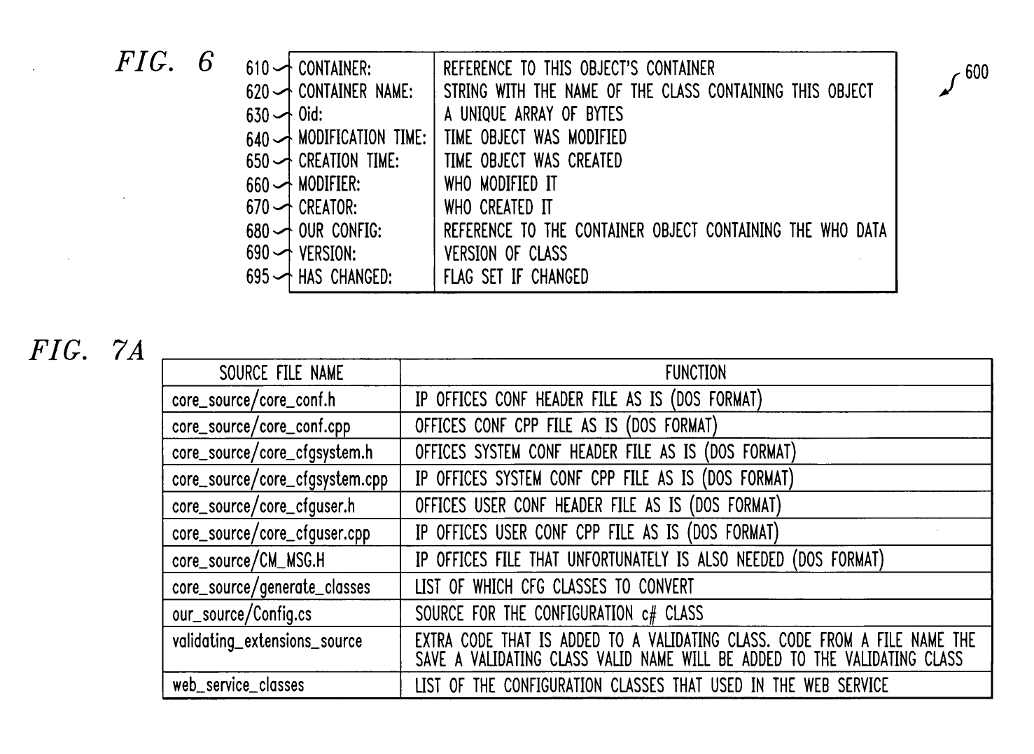

FIG. 6 illustrates an exemplary object template for each ValidationObject. As shown in FIG. 6, each ValidationObject contains a number of exemplary fields. A container field 610 records a reference to this object's container. A ContainerName field 620 records a string with the name of the class containing this object. An Oid field 630 records a unique array of bytes. A ModificationTime field 640 records the time the object was modified. A CreationTime field 650 records the time the object was created. A Modifier field 660 identifies who modified the object. A Creator field 670 identifies the creator. An OurConfig field 680 references the Root container object containing the whole data. A Version field 690 identifies the version of the class. A HasChanged field 695 provides a flag that is set if the object has changed. For each Array of objects in the raw data, an ArrayList of objects is created and the ArrayList is automatically converted to the raw data (and visa versa).

In addition, when the object is a Configuration object (i.e., the Rootobject that contains the whole hierarchy), the object also contains the following fields:

ConfigsOidHash: Hash Table of each object in this config, keyed by Oid

ModifiedList: List of objects that have been modified. This can be set at any time by the application so that it can track modification over certain intervals.

### Scripts

The administration tool 200 employs scripts to take a configuration header file, such as en exemplary file, “core_conf.h,” and generate C# classes in the Configuration namepace for both the WebService and it's client. The classes for the client (Configruation.Validating namespace) extend the web service classes with things that are useful for the administration tool 200 (for example, adding hooks for validation, making get's and set's, following copy semantics instead of reference semantics and converting arrays to ArrayLists).

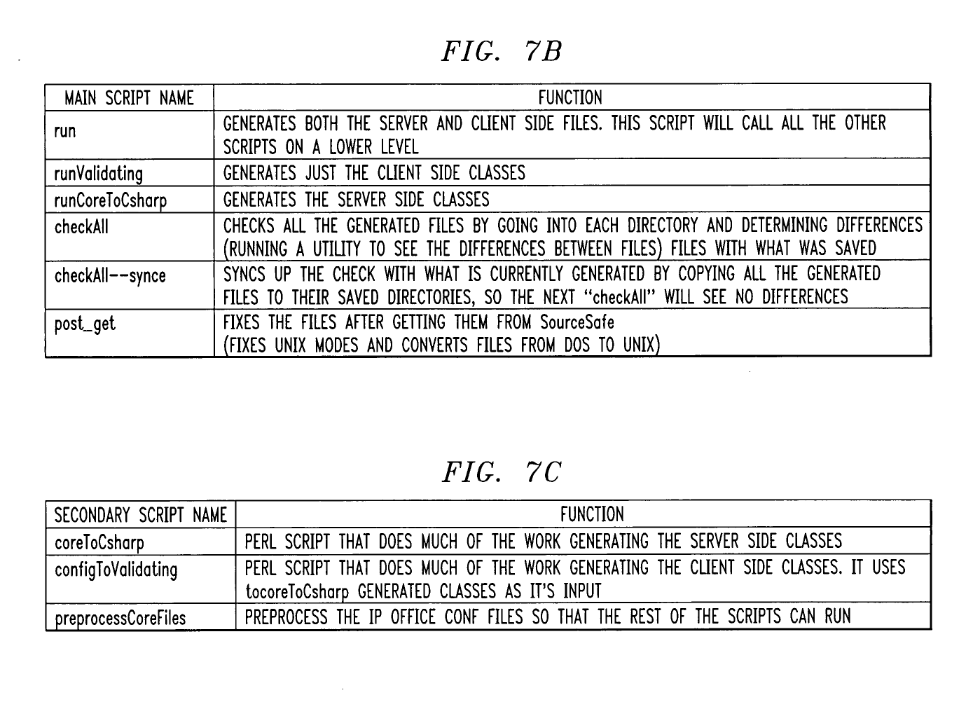

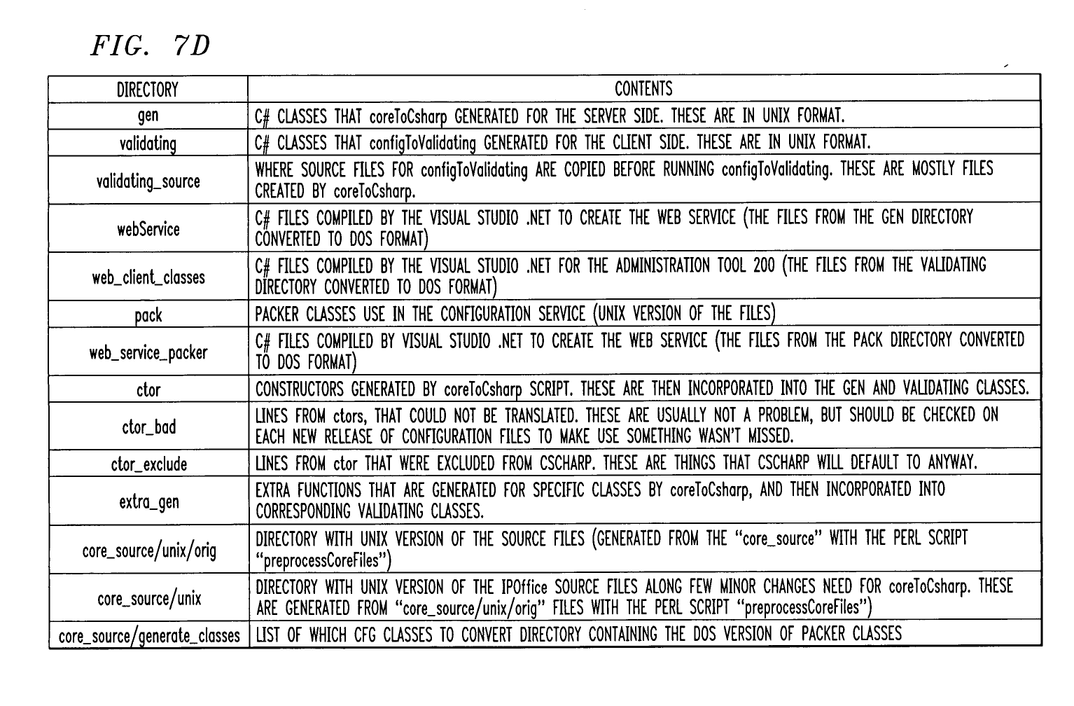

FIG. 7A is a table containing an exemplary list of source files and indicates their corresponding function. FIG. 7B is a table containing an exemplary list of main scripts and indicates their corresponding function. FIG. 7C is a table containing an exemplary list of secondary scripts that are called by the main scripts of FIG. 7B and indicates their corresponding function. FIG. 7D is a table containing an exemplary directory structure, indicating a directory name and the corresponding contents.

Configuration.Validating.Full

The Configuration.Validating.Full namespace contains classes that are representative of endpoints in the system as well as virtual entities represented by the administration tool 200. These classes are derived from those in Configuration.Validating. These classes have the additional capability of populating the default values as appropriate to the administration tool 200. In addition, these classes validate the fields within each class and generate the appropriate errors.

These classes each inherit from their corresponding Configuration.Validating class and add any customization that cannot be done by the Perl scripts. This includes any substance, e.g., specific validation rules and generation of errors to the Validating functions and any initialization that differs from the core_conf.cpp file.

These classes are not intended to be an interface to the configuration for the code of the administration tool 200. The code of the administration tool 200 should interface using the Configuration.Validating classes. The actual objects that they refer to may be of type Configuration.Validating.Full (whose functionality is achieved through dynamic binding) if the administration tool 200 has a need to extend the implementation.

Since Configuration.Validating classes have no notion of their Configuration.Validating.Full counterparts, the Configuration.Validating namespace contains a Factory class (ConfigFactory) that is used to create all objects. Config.Factory is an instance of this factory. The administration tool 200 will set Config.Factory to an Configuration.Validating.Full version at the very beginning, forcing Configuration.Validating.Full versions of the classes to be created when necessary.

Validation Rules

The Configuration.Validating.Full namespace contains classes that are representative of endpoints in the system as well as virtual entities represented by the Configuration Assistant. These classes are derived from those in Configuration.Validating. These classes have the additional capability of populating the default values as appropriate to the administration tool 200. In addition, these classes validate the fields within each class and generate the appropriate errors. For a more detailed discussion of the validation and error resolution aspects of the administration tool 200, see United States Patent Application, entitled “Method and Apparatus for Validation and Error Resolution of Configuration Data in a Private Branch Exchange Switch,” filed May 21, 2004 and incorporated by reference herein.

### Class Diagrams

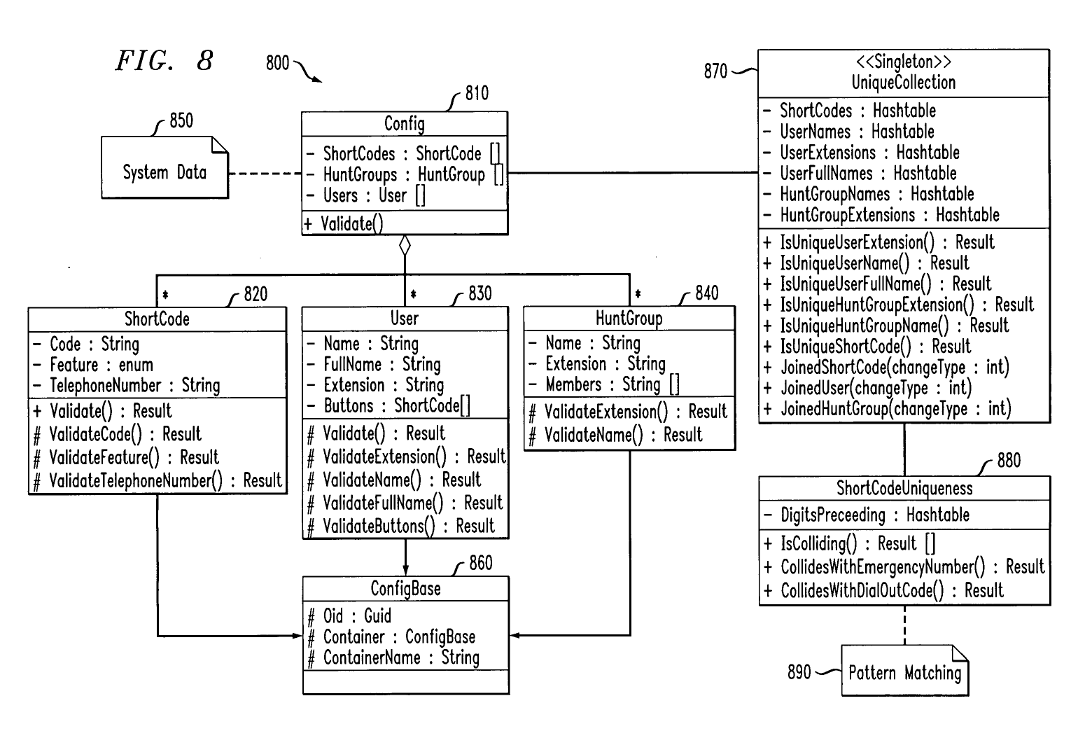

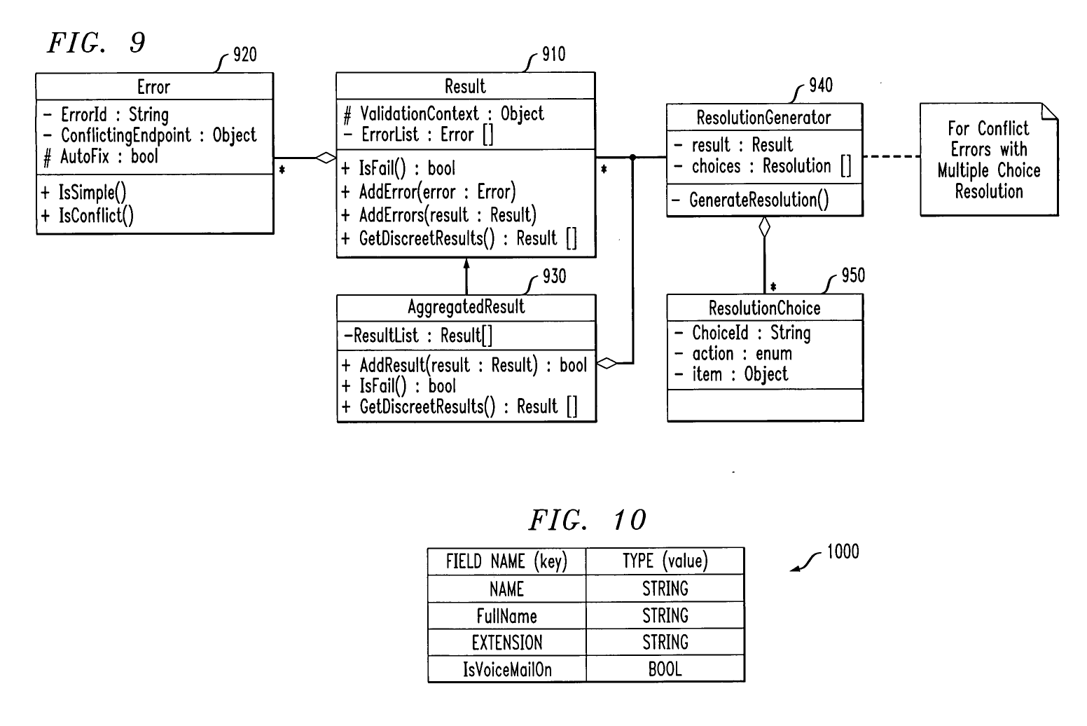

The class diagrams in FIGS. 8 and 9 illustrate the class diagram of classes in the Utilities.Error namespace. Validation always returns an object with interface Result. This result might be an aggregate or a leaf modeled after the Composite Pattern.

FIG. 8 illustrates the relationship between the various data 800 discussed herein, in accordance with exemplary Unified Modeling Language (UML) conventions. As shown in FIG. 8, a configuration object (the Root) is of type Configuration Class 810 and is an aggregation of one or more short code objects 820, user objects 830 and hunt group objects 840. The note 850 associated with the configuration class 810 indicates that a configuration object along with (recursively) all it's contained objects 810 contain the system data. Each short code object 820 is comprised of a string indicating the code, an indication of the feature associated with the short code and any additional information. Each user object 830 is comprised of a user name, full name, extension number and any short codes defined for buttons on the user's device. Each hunt group object 840 is comprised of a name and extension number associated with the hunt group, as well as a member list.

In addition, each class, such as the classes 810, 820, 830 and 840, include one or more functions applicable to the object in the third class section. For example, the configuration class 810 includes a validate function that, when called, invokes the validate functions in each of the contained objects. When the validate function in a contained object is called, such as the validate function for the short code class 820, the additional validation functions within the contained object's class (validate code, validate feature and validate telephone number) are also invoked in an iterative fashion and the results of the validation at each level of each endpoint re aggregated.

As shown in FIG. 8, the system data 800 includes a singleton class 870, referred to as “UniqueCollection.” The singleton class 870 represents all the endpoints in the system and determines whether they are unique and provides a set of hash tables to access, for example, short codes and user names, so that such classes can be more efficiently accessed. The unique collection class 870 provides a number of validation methods in the third section to ensure that they do not have data that creates a conflict. In addition, the unique collection class 870 provides a number of joined methods that report changes to the data. The short code uniqueness class 880 performs a pattern matching function (as indicated by note 890), to determine if a short code is unique and to also determine if user or hunt group extensions conflict with short codes based on a set of patterns.

FIG. 9 illustrates the relationship between the various validation's Result data classes discussed herein, in accordance with exemplary UML conventions. As shown in FIG. 9, a result object 910 identifies one or more objects being validated, and a corresponding list of errors. The result class 910 includes a number of methods in the third section for error processing. For each error type, there is a corresponding error class object 920 that identifies the error, allows any conflicting object(s) to be identified, and contains a Boolean flag indicating whether or not the error may be automatically fixed, as discussed herein.

An aggregated result class object 930 contains a collection of the validation results for a given configuration as it contains the different endpoints. In this manner, an error tree can be constructed with the class/object hierarchy. A resolution generator class 940 contains a method that facilitates the correction of errors. The resolution generator class generates the error resolution message with a list of ways to fix an error and associated actions corresponding to each selection.

FIG. 10 illustrates an exemplary types reference hash table 1000. The types reference hash tables 1000 has all the different raw data classes and their types. For each raw data class, there three type hash tables that store the types of object members one for variables (primitive types for e.g. int, bool, string etc.), one for array lists and one for storing the List Type (type of elements in each of the Array Lists). FIG. 10 is an example for a User Class that has the indicated fields in the “Variable” Hash Table.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

1. A method for managing data, comprising:
obtaining a plurality of public data structures; and
automatically generating a customizable framework for managing said plurality of public data structures, wherein said customizable framework is based on one or more parameters of said plurality of public data structures.

2. The method of claim 1, further comprising the step of generating one or more class objects from said plurality of public data structures containing one or more wrapper functions.

3. The method of claim 3, wherein said one or more wrapper functions includes a creation function.

4. The method of claim 3, wherein said one or more wrapper functions includes an accessor function.

5. The method of claim 3, wherein said one or more wrapper functions includes a modification function.

6. The method of claim 3, wherein said one or more wrapper adding functions assign at least one unique Object Identifier to each of said public data structures and requires that said at least one unique Object Identifier is unique in a system.

7. The method of claim 3, wherein said one or more wrapper functions includes a copy function.

8. The method of claim 3, wherein said one or more wrapper functions includes a function to log changes in order to create an audit trail.

9. The method of claim 3, wherein said one or more wrapper functions includes a deep clone function.

10. The method of claim 1, wherein said customizable framework provides a mechanism to create one or more of said plurality of public customizable data structures.

11. The method of claim 1, wherein said customizable framework provides a mechanism that allows one of said public data structures to track the position of said one of said public data structures in a hierarchical tree.

12. The method of claim 1, wherein said customizable framework provides a mechanism to track changes to one or more of said plurality of public data structures.

13. The method of claim 1, wherein said customizable framework provides a mechanism to detect a change to one or more of said plurality of public data structures so that said change can be propagated to any data structures referencing a changed data structure.

14. The method of claim 1, wherein said customizable framework provides a notify mechanism to allow a changed data structure to report a change to a central repository.

15. The method of claim 1, wherein said customizable framework provides one or more recursive validation methods to validate said plurality of public data structures.

16. The method of claim 15, wherein said one or more recursive validation methods validate syntax of said plurality of public data structures.

17. The method of claim 15, wherein said one or more recursive validation methods validate value constraints of said plurality of public data structures.

18. The method of claim 15, wherein one or more recursive validation methods report errors on syntax and value constraints validation of said plurality of public data structures.

19. The method of claim 15, wherein one or more recursive validation methods aggregate errors without passing results of validation on syntax and value constraints validation of said plurality of public data structures

20. The method of claim 1, wherein said customizable framework provides a mechanism that reflects changes to one or more of said plurality of public data structures in said customizable framework.

21. The method of claim 1, wherein said plurality of public data structures contain configuration data for a private branch exchange switch.

22. The method of claim 1, wherein said plurality of public data structures are raw data classes.

23. The method of claim 1, further comprising the step of generating one or more custom rules-based validation classes.

24. The method of claim 1, wherein said one or more custom rules-based validation classes is based on one or more object specific rules.

25. The method of claim 1, further comprising the step of automatically converting public data structures in a first format into a desired format.

26. The method of claim 1, further comprising the step of maintaining said public data structures in a form that may be exported to another system.

27. The method of claim 1, wherein said step of automatically generating a customizable framework is performed using one or more scripts.

28. The method of claim 1, further comprising the step of automatically generating a hash table for efficient access of one or more data objects

29. A system for managing data, comprising:
a memory; and
at least one processor, coupled to the memory, operative to:
obtain a plurality of public data structures; and
automatically generate a customizable framework for managing said plurality of public data structures, wherein said customizable framework is based on one or more parameters of said plurality of public data structures.

30. An article of manufacture for managing data, comprising a machine readable medium containing one or more programs which when executed implement the steps of:
obtaining a plurality of public data structures; and
automatically generating a customizable framework for managing said plurality of public data structures, wherein said customizable framework is based on one or more parameters of said plurality of public data structures.
